(19) United States
(12) Patent Application Publication
(10) Pub. No.: US 2004/0114297 A1
(43) Pub. Date: Jun. 17, 2004

(54) Device for suppressing the radio-interference of an electric commutator

(76) Inventors: Claus Schmiederer, Rheinau-Freistett (DE); Michael Haerer, Buehlertal (DE); Rolf Mamier, Sasbach (DE); Michael Strupp, Chungchongbuk-do (KR)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/472,040

(22) PCT Filed: Oct. 11, 2002
(86) PCT No.: PCT/DE02/03871

(30) Foreign Application Priority Data
Jan. 22, 2002 (DE) 102021619

(51) Int. Cl. H02H 9/06

(52) U.S. Cl. 361/118

(57) ABSTRACT

A device is proposed for suppressing radio interference in an electrical commutator machine, in particular a DC motor (10), having a rotor (12) supplied via brushes (14a, b) and having an interference suppression circuit (16) that has at least one capacitor and further components. The device of the invention is distinguished in that the interference suppression circuit (16) on the one hand has an interference suppression ring comprising individual interference suppression elements (56), which contain at least one varistor (28and/or at least one capacitor (30) and cooperate with at least one further outer interference suppression capacitor. The individual interference suppression elements (56) of the interference suppression ring (24) are either located between adjacent laminations (32) of the commutator (34) or are connected by one terminal to one lamination (34) and by the respective second terminal to one another to form a virtual zero point 33).

### PRIOR ART

The invention relates to a device for suppressing radio interference in an electrical commutator machine, in particular a DC motor, as generically defined by the preamble to claim 1. Such interference suppressors for electric motors are commonly used in motor vehicles.

Furthermore, from European Patent Disclosure EP 0 369 746 A, an electrical small DC motor is known whose commutator is equipped with a ring-shaped varistor assembly to suppress radio interference. The varistor ring is connected to the laminations of the commutator by means of a number of contacts that correspond to the number of commutator laminations. A face end of the varistor ring can be coated with conductive material, to embody a capacitor between the individual commutator laminations. The varistor ring is connected to the commutator laminations via connection wires. Such an arrangement has only limited interference suppression capacity and is effective in only a partial range of the frequency band of interest here.

From German Patent Disclosure DE 199 53 231 A, an electric motor with a means for suppressing radio interference is known that is embodied in ring form and is disposed directly on the commutator. The interference suppression means, comprising ceramic material, can indeed be produced with a small structural size and disposed directly on the commutator, but because of the ceramic material and the electrical values specified by the production method, only a limited interference suppression effect is attainable.

The object of the invention is to improve known devices for suppressing radio interference in electrical commutator machines, in particular DC motors, in such a way that a satisfactory interference suppression capacity over a wide range of interference frequency is attained. This is achieved by the definitive characteristics of claim 1.

It has proved advantageous if the interference suppression ring is coupled with a delta circuit comprising outer capacitors between the connection terminals of the electrical machine for forming the interference suppressor; one leg of the delta circuit is located between the motor connection terminals, while the other two legs of the delta circuit are connected to one another and are connected jointly to ground. With this kind of overall device, in the interference suppression ring on the one hand and in the outer interference suppression capacitors on the other, capacitances for suppressing interference in certain frequency bands can be specified in a targeted way. The outer interference suppression capacitor between the connection terminals of the electrical machine is operative particularly in the lower interfering frequency range in radio reception, that is, especially in the long-wave and medium-wave range, while the other two capacitors, connected to one another by one terminal and connected to ground, are operative particularly in the frequency range above 30 MHz, or in other words especially in the ultra-short wave range. By the inventive combination of the interference suppression ring with at least one further outer interference suppression capacitor, a very small structural size of all the interference suppression elements is made possible as well, which in turn allows the interference suppression elements to be disposed directly in the region of the electric motor where the interference occurs, or in other words in the region of the commutator and brushes.

The inventive combination of the space-saving interference suppression ring with the relatively small outer capacitors especially advantageously makes it possible to embody the outer capacitors as SMDs (surface mounted devices) and to dispose them on a printed circuit board directly on the brush holder, preferably between the connection terminals of the brushes. The brush holder itself then serves as an electrical and mechanical support for the printed circuit board; as a result, not only are additional fastening parts dispensed with, but it also advantageously becomes possible to dispose them directly in the region where the interference is created.

The interference suppression ring is expediently disposed directly on the commutator, where it is secured electrically and mechanically. It is possible in particular for the interference suppression ring to be integrated with the commutator support or secured directly to it, and as a result once again a disposition of the interference suppression ring directly in the region where the interference occurs and should be suppressed can be achieved.

In terms of the structure and the connection of the interference suppression ring, two variants have proved especially advantageous. Either the individual elements of the interference suppression ring can each be contacted by one of its terminals to a commutator lamination, while the other terminals of the interference suppression elements are connected to one another and thus form a virtual zero point. The other advantageous connection possibility for the various elements of the interference suppression ring is for them to be connected by both terminals to adjacent commutator laminations. Parallel to this series circuit of interference suppression elements via the commutator laminations, it is also possible for there to be a direct connection of the elements with one another.

Further details and advantageous refinements of the invention will become apparent from the description of the exemplary embodiments in conjunction with the drawings. Shown are

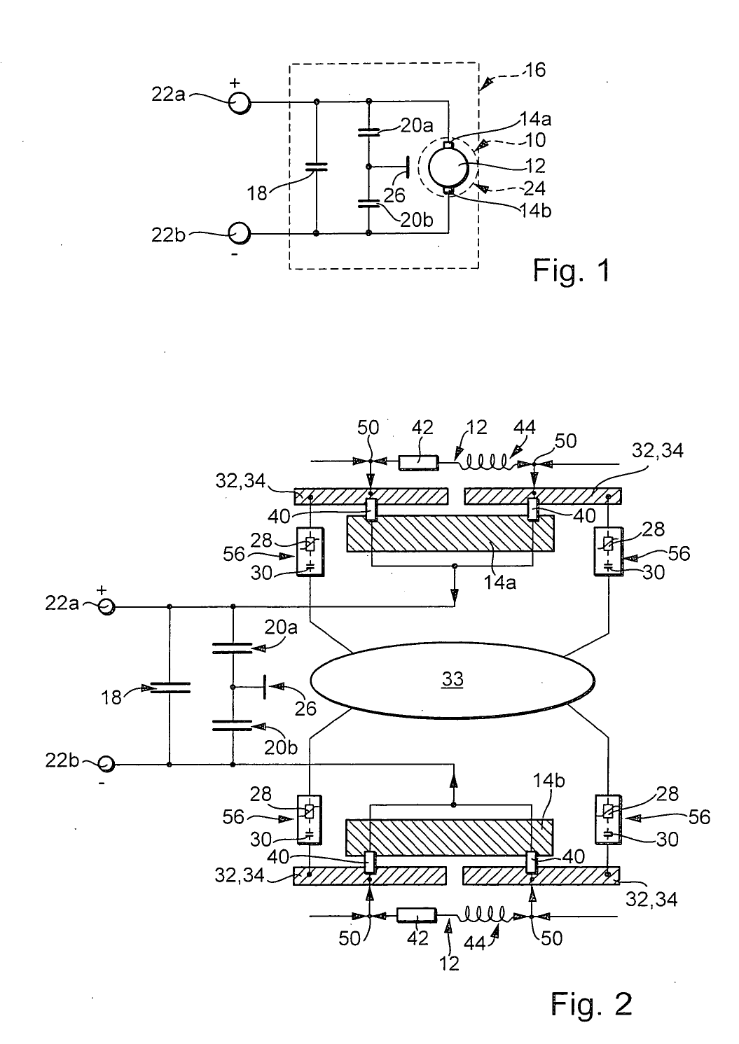

FIG. 1, a basic illustration of a device of the invention for suppressing radio interference in an electrical commutator machine;

FIG. 2, a first exemplary embodiment of a circuit arrangement for suppressing radio interference in a commutator machine, in which the individual elements of the interference suppression ring are interconnected to form a virtual zero point;

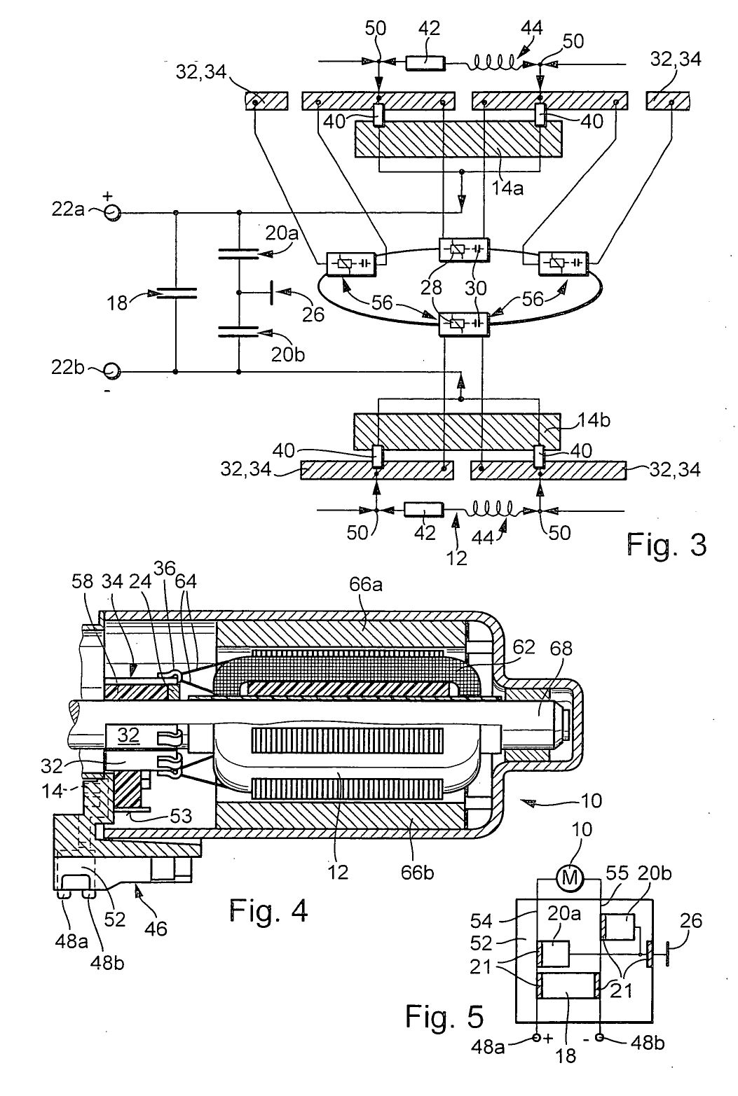

FIG. 3, a second exemplary embodiment of a circuit arrangement for suppressing radio interference in a commutator machine, in which the individual elements of the interference suppression element are each connected to adjacent commutator laminations;

FIG. 4, a longitudinal section through a DC motor with a device according to the invention for suppressing radio interference; and

FIG. 5, a circuit diagram of a printed circuit board with interference suppression capacitors of SMD construction.

FIG. 1 illustrates the principle of a device according to the invention for suppressing radio interference in a DC motor 10, whose rotor 12 is connected to a direct-current (DC) system via brushes 14a and 14b. An interference suppression circuit 16, outlined with dashed lines, for the DC motor 10 contains outer interference suppression capacitors 18, 20a and 20b; as a rule, the capacitor 18 is designated as Cx and the capacitors 20a and 20b as Cy. The capacitor 18 is located between the connection terminals 22a and 22b of the DC system, and the capacitors 20a and 20b are connected in series, likewise between the connection terminals 22a and 22b; the junction of the capacitors 20a and 20b is located at a ground terminal 26. The outer interference suppression capacitors 18, 20a and 20b thus form a delta circuit, two corner points of which are connected to the connection terminals 22a and 22b of the motor, and the third corner point is connected to ground 26.

As a further interference suppression provision, the interference suppression circuit 16 includes an interference suppression ring 24, whose structure and wiring will be explained further hereinafter. The interference suppression ring 24, which can also be embodied as a disk, is associated directly with the brushes 14a, b of the rotor 12 and thus with the interference source of the motor. This applies to a high degree for the outer interference suppression capacitors 18 and 20a, 20b as well, as will be described in further detail hereinafter in conjunction with the other drawings. In contrast to conventional circuits for suppressing radio interference in an electric motor, which are typically realized by attaching an external interference suppression filter, by means of the device of the invention a spatial and structural optimization of the interference suppressor is achieved, which in particular allows the interference suppression elements to be integrated directly with the region of the interference source, namely the commutation system comprising the commutator and brushes. The interference suppressor of the invention, because of this capability of integration with the commutation system, makes do without inductances in the lead lines to the motor, which in conventional circuits, because of their disposition in the motor connection lines, must be designed for the full motor current and therefore have a considerable component size and entail high costs.

In FIG. 2, the rotor 12 of a DC motor is shown in more detail in the region of the brushes 14a, 14b. The disposition of the capacitors 18 as well as 20a and 20b has already been explained in conjunction with FIG. 1 and remains unchanged in the arrangement of FIG. 2. The individual components of the interference suppression ring 24 are identified in FIG. 2 by reference numeral 56. In the embodiment shown, they each contain one varistor 28 and one capacitor 30; the varistor 28 can also be replaced with or supplemented with an ohmic resistor. Reference numeral 32 indicates the laminations of the commutator 34, and the individual interference suppression elements 56 are connected to the respective laminations by one terminal each. The transition resistor between one brush 14a, 14b and one lamination 32 of the commutator 34 is identified by reference numeral 40. The ends, remote from the laminations 32, of the interference suppression components 56 are joined together in a ring in the arrangement of FIG. 2 and form a virtual zero point 33.

The winding of the rotor 12 is represented in FIG. 2 by the respective winding resistor 42 and the respective winding inductance 44 between two commutator laminations 32; the winding terminals on the commutator are identified by reference numeral 50.

In operation of the motor, upon each commutation sparks are created, since upon displacement of a brush 14a, b from one lamination 32 to the next, the corresponding winding inductance 44 is short-circuited via the winding resistor 42 and the brush transition resistors 40. However, the energy stored in the winding inductance 44 cannot be completely dissipated, if the short circuit via the brush 14a or 14b ends before the energy stored in the winding inductance 44 has been dissipated in the form of heat in the winding resistor 42. In that case, a spark discharge develops between the brush 14 and the trailing end of the lamination 32; on the one hand, this shortens the service life of the motor, and on the other it causes the radio interference. This is what the proposed provisions now seek to suppress, or at least reduce to an amount that is tolerable in terms of electromagnetic compatibility (EMC); the emphasis is in particular on conducted interference in the long-, medium- and short-wave ranges.

According to the invention, the radio interference can now be achieved in an especially effective and economical way by combining the interference suppression ring 24 with at least one outer capacitor 18; each element of the interference suppression ring 24 preferably includes one varistor 28 and one capacitor 30. The interference suppression ring 24 is effective particularly in the frequency range from approximately 30 MHz to 120 MHz, or in other words particularly in the ultra-short wave range, while the outer interference suppression capacitor or capacitors 18 is especially effective in the frequency range below that, or in other words in the range of long-wave, medium-wave and short-wave radio frequencies. The outer capacitor 18 has a capacitance between 150 nF and several μF. If the outer interference suppression capacitors 20a and 20b are added, each of which has approximately 1/10 the capacitance of the capacitor 18, then the effectiveness of the delta circuit comprising the filter capacitors 18, 20a and 20b attains approximately 10 kHz to approximately 50 MHz. Thus by combining both interference suppression provisions, the entire interfering voltage frequency range of interest can be covered, and even nonconducted interference field intensities in the ultra-short wave range can be suppressed. The outer interference suppression capacitors 20a and 20b, connected to one another by one end and connected to ground, also reinforce the effect of the interference suppression ring 24, whose individual elements 56, because of their interconnection to form a virtual zero point 33, exhibit a similar action. The capacitances of the capacitors 30 of the components 56 are between approximately 1 nF and 300 nF; for a current passage of 10 mA, the varistors 28 generate a voltage drop of between about 1 V and 100 V. Additional ohmic resistors in series or optionally also in parallel with the varistor 28 and/or the capacitor 30 of the interference suppression elements 56 can have a resistance of between approximately 1 ohm and 100 kohm. The capacitive component of the interference suppression elements 56 is also dictated by their structure, since the interference suppression elements 56 made from ceramic material have a certain capacitance, which can be varied within limits by means of manufacturing provisions.

The circuit arrangement of FIG. 3 is largely equivalent to that of FIG. 2; identical elements are identified by the same reference numerals and will not be described again here. In a departure from the circuit arrangement of FIG. 2, where the interference suppression elements 56 are connected by only one of their terminals to a commutator lamination 32, the individual interference suppression elements 56 in the arrangement of FIG. 3 are connected by both electrical terminals to adjacent laminations 32. Adjacent interference suppression elements 56 are thus connected to one another via the laminations 32. In addition, via connections among their terminals, they are directly in electrical contact with one another and thus form an interference suppression ring. In contrast to this, the contact plane of the connecting ring 33 in FIG. 2 has no electrical low-frequency connection, but instead together with the ring 33 forms a virtual zero point. In the circuit arrangement of FIG. 3, all the interference suppression elements 56 are connected in series and are thus electrically coupled. The commutation energy stored in the winding inductance 44 is absorbed here, each by a respective interference suppression element 56. This circuit could also be embodied with discrete components, for instance of the SMD type, with the circuit elements disposed on the commutator 34 between the laminations 32.

In the arrangement of FIG. 2, the damping of the interference voltage pulse is thus effected via at least two series-connected interference suppression elements 56. These elements together form an interference suppression unit, connected parallel to the motor terminals, which damps not only the commutation brush fire but also interference pulses in the on-board electrical system.

In the arrangement of FIG. 3, conversely, the damping of the interference voltage pulse is effected via a single interference suppression element 56, which is directly in electrical contact, by its terminals, with the combination of carbon brush and commutator lamination that acts as a load switch. Because of this greatest possible spatial closeness of the interference suppression element 56 to the interference source, optimal interference suppression can be achieved.

FIG. 4 shows a longitudinal section through a DC motor 10; once again, identical elements have the same reference numerals as in FIGS. 1-3 above. The motor is shown in section in the upper part and cut away in the lower part, in which a brush 14 and the surface of the laminations 32 are visible. As can be seen from the sectional view in the upper part of FIG. 4, the interference suppression ring 24 is united with the base body 58 of the commutator and is located below the connection hooks 36 of the commutator laminations 34. Alternatively, it would be possible to secure the interference suppression ring 24 to the outer end face of the commutator base body 58 either directly or indirectly.

The armature winding 62 is secured to the connection hooks 36 via commutator connection wires 64, and these securing points correspond to the winding terminals 50 of FIGS. 2 and 3. The brushes 14 are seated on the commutator laminations 32 and are held in turn in the brush holder 46 and are pressed against the commutator 34 by a compression spring 53. The brush holder 46 also has plug terminals 48a and 48b, which correspond to the connection terminals 22a and 22b of FIGS. 2 and 3. A printed circuit board 52 is secured mechanically and electrically to these plug terminals 48a, b and is shown in further detail in terms of its structure in FIG. 5.

Finally, in FIG. 4, the stator magnets 6a and 6b, which are embodied as permanent magnets, can also be seen. The rotor 12, including the commutator 24, is seated on the rotor shaft 68; other structural details are not shown. What appears essential is that the entire device for suppressing radio interference is concentrated in the region of the brush holder and the commutator, so that interference can be suppressed directly where it occurs, and line connections are maximally avoided.

In FIG. 5, the printed circuit board 52 is shown with the capacitors 18 as well as 20a and 20b. The conductor tracks leading from the plug terminals 48a and 48b of the brush holder 46 to the brushes of the motor 10 are identified by reference numerals 54 and 55. The capacitors 18, 20a and 20b, embodied as SMDs, are in direct electrical contact with these tracks 54 and 55 via metallizing terminals 21. A further connection exists in the printed circuit board 58, where one terminal of each of the capacitors 20a and 20b is also in electrical contact, as in the circuit arrangements of FIGS. 2 and 3.

The compact design of the entire device for suppressing radio interference is thus created by combining the interference suppression ring 24 with discrete interference suppression elements in the form of the interference suppression capacitors 18, 20a and 20b; these capacitors, because of the relatively low capacitances required, can be embodied in an especially space-saving way as SMDs, which in turn, as with the interference suppression ring 24, opens up the capability of accommodating them in the immediate vicinity of the interference source. Complicated, expense interference suppression inductances can be dispensed with, and complete interference suppression for a motor is possible without hard-wired components; in turn, as a result, a reduction in parasitic propagation constants per unit length is attained. Finally, the brush holder 46 can also be embodied more compactly and with a lighter weight, since it need not hold any relatively large discrete components.

1. A device for suppressing radio interference in an electrical commutator machine, in particular a DC motor, having a rotor supplied via brushes and having an interference suppression circuit which has at least one capacitor and preferably further interference suppression elements, characterized in that the interference suppression circuit (16) includes on the one hand an interference suppression ring (24) or an interference suppression disk having at least one varistor (28) or a resistor and/or at least one capacitor (30), and on the other at least one further outer interference suppression capacitor (18, 20).

2. The interference suppressor of claim 1, characterized in that the interference suppression ring (24) is coupled to at least one outer interference suppression capacitor (18, 20) between the connection terminals (22a, b) of the electrical machine (10).

3. The interference suppressor of claim 1 or 2, characterized in that the interference suppression ring (24) is coupled with a delta circuit comprising outer capacitors (18; 20a, b), which delta circuit is connected on one side between the motor connection terminals (22a, b) and on the other to ground (26).

4. The interference suppressor of one of the foregoing claims, characterized in that the outer capacitor or capacitors (18; 20a, b) and/or the interference suppression ring (24) are structurally closely connected to the interference source (34, 38).

5. The interference suppressor of one of the foregoing claims, characterized in that the outer capacitor or capacitors (18; 20a, b) are disposed on a printed circuit board (52).

6. The interference suppressor of claim 5, characterized in that the printed circuit board (52) is secured electrically and mechanically to the brush holder (46).

7. The interference suppressor of one of the foregoing claims, characterized in that the further interference suppression capacitors (18; 20a, b) are embodied as SMDs and are disposed on a printed circuit board (52), preferably on the brush holder (46).

8. The interference suppressor of one of the foregoing claims, characterized in that the interference suppression ring (24) is secured electrically and mechanically to the commutator (34).

9. The interference suppressor of one of the foregoing claims, characterized in that the interference suppression ring (24), between adjacent winding terminals (50) on the commutator (34), has at least one varistor (28) and one capacitor (30) each as interference suppression elements.

10. The interference suppressor of one of the foregoing claims, characterized in that the individual elements (28, 30) of the interference suppression ring (24) are each contacted on the one hand by one terminal to a commutator lamination (32) and on the other by its second terminal to one another, in order to form a virtual zero point (33).

11. The interference suppressor one of claims 1-9, characterized in that the individual elements (28, 30) of the interference suppression ring (24) are connected by their two terminals to adjacent commutator laminations (32) and/or directly to one another.
